(19) United States
(12) Patent Application Publication
(10) Pub. No.: US 2025/0226137 A1
(43) Pub. Date: Jul. 10, 2025

(54) MAGNETIC POSITIONING STRUCTURE FOR EXPANDED DEVICE

(71) Applicant: ADAM ELEMENTS INTERNATIONAL CO., LTD., TAIPEI CITY (TW)

(72) Inventors: CHUNG-YING CHANG, TAIPEI CITY (TW); HUNG-YI LIN, TAIPEI CITY (TW); ZHENG-YI WU, TAIPEI CITY (TW)

(21) Appl. No.: 18/820,284

(22) Filed: Aug. 30, 2024

(30) Foreign Application Priority Data
Jan. 8, 2024 (TW) 113200250

(51) Int. Cl. H01F 7/02

(52) U.S. Cl. CPC H01F 7/02

(57) ABSTRACT

A magnetic positioning structure for an expanded device includes a magnetic positioning plate and at least one magnetic conductive element. The magnetic positioning plate with a fixing surface and a mounting surface fixed on a plane includes at least one first magnetic element and an anti-slip sleeve, the first magnetic element is enclosed in the anti-slip sleeve, and the magnetic conductive element is arranged in a housing of the expanded device. In this way, the magnetic conductive element can quickly and temporarily fix the expanded device to the mounting surface of the magnetic positioning plate, and the anti-slip sleeve can prevent displacement of the expanded device. The magnetic positioning structure is applicable to expanded devices such as hubs, notebook docking stations, power banks, etc. to prevent random shaking, keep the operating environment neat without causing wire entanglement or affecting connection angles, thus greatly improving the convenience of use.

### CROSS-REFERENCE TO RELATED APPLICATIONS

This non-provisional application claims priority under 35 U.S.C. § 119 (a) on Patent Application No(s). 113200250 filed in Taiwan, R.O.C. on Jan. 8, 2024, the entire contents of which are hereby incorporated by reference.

### BACKGROUND OF THE DISCLOSURE

### Technical Field

The present disclosure relates to the technical field of electronic products storage applications, and particularly relates to a magnetic positioning structure for expanded devices. Through a magnetic positioning plate that can be mounted on various planes, and at least one magnetic conductive element that can be mounted on the expanded device, the magnetic attraction between magnetic positioning plate and the magnetic conductive element allows the expanded device to be quickly and temporarily fixed to the plane, thereby avoiding random shaking during use, keeping the operating environment beautiful and neat without causing wire entanglement or affecting connection angle.

### Description of the Related Art

At present, 3C electronic products, such as notebook computers, mobile phones and tablet computers, are changing day by day and have a high popularity rate. In order to make them easier to carry and use, these 3C electronic products are designed with the features of reduced volume and weight, and so on. Therefore, most of these 3C electronic products only have a very few power ports or signal ports to provide the expansion required for subsequent use, such as the use of a common notebook computer that often needs to use a variety of connections including an input connection of a mouse, a keyboard or a presentation device, and an output connection of a video projector or a printer. Although most of the current expansion means are used in the way of wireless transmission, but due to the limitations of use, sometimes the expansion cannot be carried out in a wireless manner for data transmission. Therefore, an expansion device will be needed for the purpose of expanding the notebook computers, and one of the common expansion devices is an expansion docking station. In order to carry these expansion docking stations conveniently, their size should be reduced greatly, in addition to their easy use and carry.

However, these docking stations have different types of expansion ports and require different data transmission cables or power cables to connect to the notebook computer for signal or data transmissions. In addition, the angle of placement and the length of the cable often increase the difficulty of expansion, since most docking stations are placed on a side of the notebook computer, and expansion is carried out through various cables. With different application requirements, the number of cables used also varies, which often leads to problems such as tangling or limited insertion angles due to different lengths of cables. Often in use, users have to repeatedly adjust the position or change the length of the wire, and constantly change the docking placement angle or position, so that in the conventional common use, the docking station will be temporarily fixed to the already adjusted position, but the bottom of most of these docking stations only has an anti-slip sheet or a fixing hole structure as a means for fixation, which is not stable enough or may destroy the mounting plane. If the anti-slip sheet or the fixing hole structure is attached with adhesive, it may have the difficulty of removing them afterwards. Alternatively, magnets are used to assist in the fixation, but not all planes can be magnetically attracted, so the use of these expansion devices is quite inconvenient. For example, a common power bank has various types of connectors for different models of mobile phones, such as TYPE-C, MICRO USB, and Lightning connectors. In addition to the need of bringing the corresponding charging cable, there is another problem for users to pay attention to the position of placing the power bank when use in order to avoid bending and damaging the charging cable or causing the charging cable unable to charge. Therefore, how to make the expansion device to be a good and convenient means of fixation is more important, and all manufacturers are working hard to find feasible solutions and improvements.

In view of the aforementioned problems, the present discloser based on years of experience in the related industry to conduct extensive experiment and research, and finally developed a magnetic positioning structure for expanded devices in accordance with the present disclosure, which uses a combination of a magnetic positioning plate and at least one magnetic conductive element to mount the magnetic positioning plate having a first magnetic element and an anti-slip sleeve onto a plane according to the requirements, and then mount the magnetic conductive element onto the housing of the expanded device to quickly and temporarily fix the magnetic conductive element to the plane for use. This magnetic positioning structure can avoid wire entanglement and the affection on the connection angle during use, thus greatly improving the convenience of use.

### SUMMARY OF THE DISCLOSURE

The primary objective of the present disclosure is to overcome the aforementioned problems by providing a magnetic positioning structure for expanded devices, which includes a magnetic positioning plate and at least one magnetic conductive element, the magnetic positioning plate includes at least one first magnetic element and an anti-slip sleeve for enclosing the first magnetic element in the anti-slip sleeve, the magnetic conductive element is installed on the housing of the expanded device, the magnetic conductive element provided for magnetically attaching the expanded device, and the anti-slip sleeve with its anti-slip effect prevent displacement of the expanded device, so as to prevent random shaking, keep the operating environment neat without causing wire entanglement or affecting connection angles, thus greatly improving the convenience of use.

To achieve the aforementioned objective, the present disclosure discloses a magnetic positioning structure for expanded devices, wherein the expanded device includes a hub, a notebook docking station and a power bank, the expanded device has a metal or non-metal housing, the magnetic positioning structure is provided for quickly and temporarily fixing the expanded device onto a plane of various materials to avoid affecting the use due to displacement. The magnetic positioning structure includes: a magnetic positioning plate which is a sheet structure having a fixing surface and a mounting surface, the fixing surface is fixed onto the plane, the magnetic positioning plate includes at least one first magnetic element and an anti-slip sleeve, and the first magnetic element is enclosed in the anti-slip sleeve; and at least one magnetic conductive element, installed on the housing of the expanded device; during use, the magnetic conductive element is provided for quickly and temporarily fixing the expanded device onto the mounting surface of the magnetic positioning plate, and the anti-slip sleeve with its anti-slip effect prevents displacement of the expanded device.

In an embodiment of the present disclosure, the anti-slip sleeve is made of rubber, silicone or soft plastic and formed into a shape corresponding to the shape of the first magnetic element, and it can fine-tune the surface angle corresponding to the plane of different materials and effectively prevent slipping. In addition, the anti-slip sleeve of the present disclosure is manufactured by an embedded injection molding method, a hybrid injection molding, bonding method, a bonding method and an embedding method and covered onto the outside of the first magnetic element without the risk of falling off. In another embodiment of the present disclosure, the magnetic positioning structure for expanded devices further includes an adhesive plate which is a double-sided tape or a reusable nanopatch. The adhesive plate is provided for fixing the magnetic positioning plate onto a non-metal plane. When a nano adhesive pad is used, in addition to its reusable feature, the first magnetic element is completely enclosed in the anti-slip sleeve, so the adhesive pad can be cleaned directly to increase the adhesiveness.

In another embodiment of the present disclosure, the magnetic conductive element is a metal sheet, a second magnetic element or the combination. It is noteworthy that the magnetic conductive element is a sheet structure having an adhesive pad disposed on a surface of the magnetic conductive element for adhesion, and the adhesive pad is a double-sided tape or a reusable nanopatch. Therefore, the magnetic conductive element can be attached to the inside or outside of the housing, or the magnetic conductive element is manufactured into a shape corresponding to the shape of the housing of the expanded device directly. In addition, the first magnetic element and the second magnetic element with opposite magnetic poles are arranged relative to each other, and the first magnetic element and the second magnetic element are in a round shape, a rectangular shape, a triangular shape, or another geometric shape.

### BRIEF DESCRIPTION OF THE DRAWINGS

FIG. 1 is a schematic view showing the structure of a preferred embodiment of the present disclosure;

FIG. 2 is a first schematic view showing the using status of a preferred embodiment of the present disclosure;

FIG. 3 is a second schematic view showing the using status of a preferred embodiment of the present disclosure; and

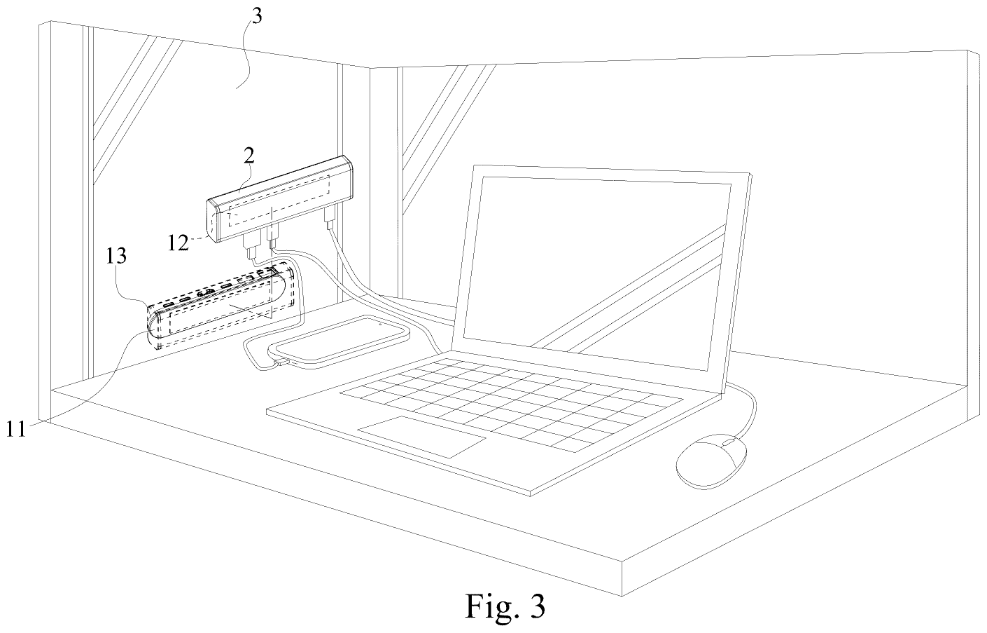

FIG. 4 is a schematic view showing the structure of another preferred embodiment of the present disclosure.

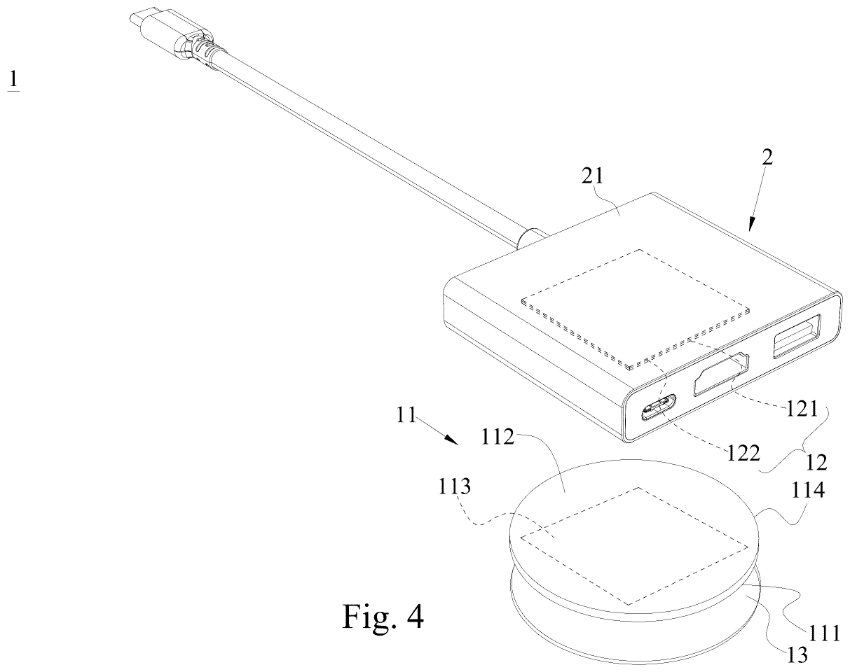

### DESCRIPTION OF THE PREFERRED EMBODIMENTS

The objectives, technical contents and features of this disclosure will become apparent in the following detailed description of the preferred embodiments with reference to the accompanying drawings.

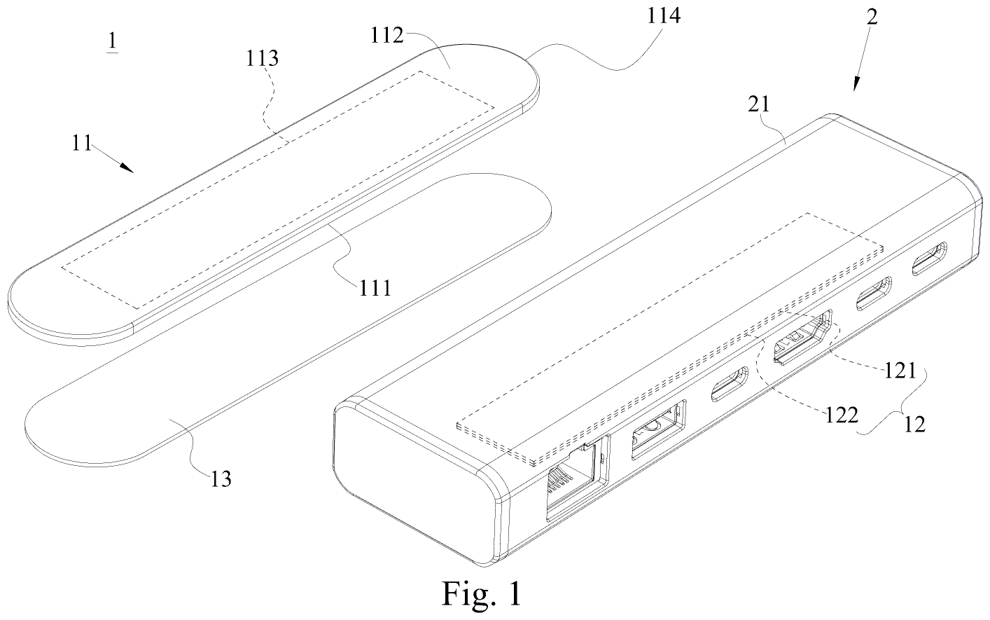

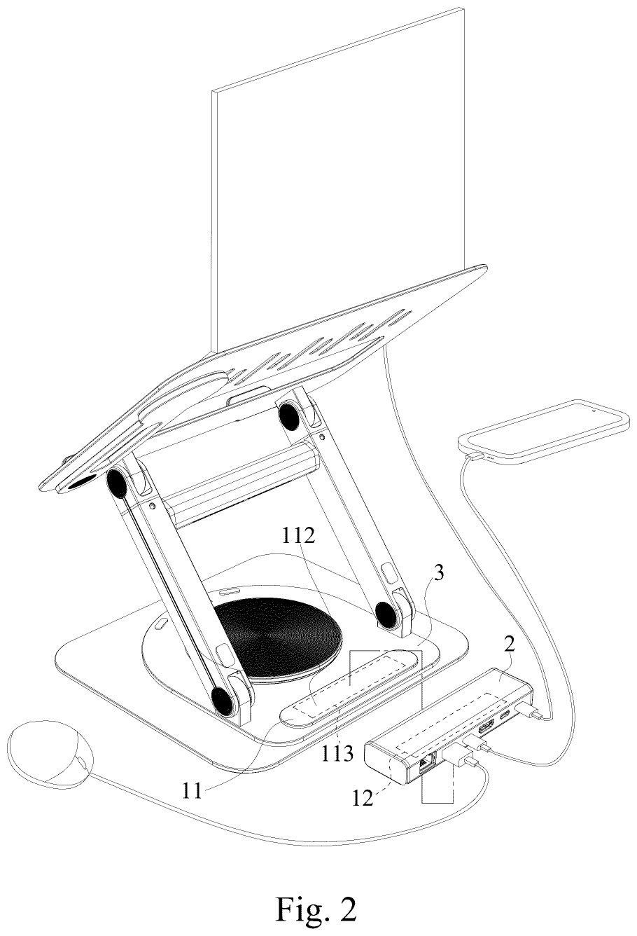

With reference to FIGS. 1, 2˜3 and 4 for the schematic structural view and schematic view of different using statuses of a preferred embodiment, and the schematic structural view of another preferred embodiment of the present disclosure respectively, the magnetic positioning structure 1 for expanded device 2 of the present disclosure includes a magnetic positioning plate 11 and a plurality of magnetic conductive elements 12, wherein the expanded device 2 includes a hub, a notebook docking station and a power bank, the expanded device 2 has a metal or non-metal housing 21, the magnetic positioning structure 1 is provided for quickly and temporarily fixing the expanded device 2 onto a plane 3 of various materials to avoid affecting the use due to displacement.

Wherein, the magnetic positioning plate 11 is a sheet structure having a fixing surface 111 and a mounting surface 112, the fixing surface 111 is fixed onto the plane 3, the magnetic positioning plate 11 includes at least one first magnetic element 113 and an anti-slip sleeve 114, and the first magnetic element 113 is enclosed in the anti-slip sleeve 114. It is noteworthy that the anti-slip sleeve 114 of the present disclosure is made of one selected from rubber, silicone and soft plastic and formed in the shape corresponding to the shape of the first magnetic element 113, and the anti-slip sleeve 114 is manufactured by a method selected from an embedded injection molding method, a hybrid injection molding, bonding method, a bonding method and an embedding method, so that the anti-slip sleeve 114 can be integrally formed and covered onto the outside of the first magnetic element 113. In addition, the magnetic positioning structure 1 of the present disclosure further includes an adhesive plate 13 arranged on the fixing surface 111, and the adhesive plate 13 is provided for fixing the magnetic positioning plate 11 onto a non-metal plane 3 such as a glass surface, a wall surface or a wooden surface. Due to the magnetic property of the adhesive plate 13, it can be fixed onto a magnetically conductive metal surface directly.

The magnetic conductive elements 12 are installed on the housing 21 of the expanded device 2, and made of a metal sheet, a second magnetic element 122 or their combination, and the magnetic conductive element 12 is a sheet structure having an adhesive pad 121 on a surface of the sheet structure for adhesion. It is noteworthy that the adhesive pad 121 is a double-sided tape or a reusable nanopatch, which can attach the magnetic conductive element 12 to the inside or outside of the housing 2, or the magnetic conductive element 12 is manufactured into a form corresponding to the shape of the housing 21 of the expanded device 2 directly. In addition, the first magnetic element 113 and the second magnetic element 122 with opposite magnetic poles are arranged relative to each other, and the first magnetic element 113 and the second magnetic element 122 are in a geometric shape such as a round shape, a rectangular shape, a triangular shape, etc. During use, the magnetic conductive element 12 is provided for quickly and temporarily fixing the expanded device 2 fixed onto the mounting surface 112 of the magnetic positioning plate 11, and the anti-slip sleeve 114 with its anti-slip effect prevents displacement of the expanded device 2.

Accordingly, the magnetic positioning structure of the present disclosure includes using the anti-slip sleeve 114 to cover the magnetic positioning plate 11 formed by the first magnetic element 113 to quickly and temporarily fix the magnetic positioning structure onto the plane 3, and mounting the magnetic conductive element 12 on the housing 21 of the expanded device 2 in a variety of ways, so that the expanded device 2 is magnetically attached to the magnetic positioning plate through the magnetic conductive element 12, and the anti-slip sleeve 114 with its anti-slip effect prevents displacement of the expanded device 2 during use, avoiding random shaking of the device, making the operating environment beautiful and neat without causing wire entanglement or affecting the connection angle, and improving the convenience of use.

What is claimed is:

1. A magnetic positioning structure for an expanded device, the expanded device comprising and a housing that is made of metal or non-metal material, the magnetic positioning structure being provided for quickly and temporarily fixing the expanded device onto a plane of various materials to avoid affecting a usage due to displacement of the expanded device, and the magnetic positioning structure comprising:
a magnetic positioning plate being a sheet structure having a fixing surface and a mounting surface, the fixing surface being fixed onto the plane, and the magnetic positioning plate comprising at least one first magnetic element and an anti-slip sleeve, the at least one first magnetic element being enclosed in the anti-slip sleeve; and
at least one magnetic conductive element arranged on the housing of the expanded device,
wherein during the usage, the at least one magnetic conductive element is provided for quickly and temporarily fixing the expanded device onto the mounting surface of the magnetic positioning plate, and the anti-slip sleeve has an anti-slip effect for preventing the displacement of the expanded device.

2. The magnetic positioning structure according to claim 1, wherein the anti-slip sleeve is made of one selected from the group of a rubber, a silicone, and a soft plastic, and is formed into a shape corresponding to a shape of the at least one first magnetic element.

3. The magnetic positioning structure according to claim 2, wherein the anti-slip sleeve is manufactured by a method selected from the group of an embedded injection molding method, a hybrid injection molding, a bonding method, and an embedding method, and is covered onto an outside of the at least one first magnetic element.

4. The magnetic positioning structure according to claim 1, further comprising an adhesive plate arranged on the fixing surface, and provided for fixing the magnetic positioning plate onto a non-metal plane.

5. The magnetic positioning structure according to claim 1, wherein the at least one magnetic conductive element is one selected from the group of a metal sheet, a second magnetic element, and a combination thereof.

6. The magnetic positioning structure according to claim 5, wherein the at least one magnetic conductive element is a sheet structure, and one side of the at least one magnetic conductive element is provided with an adhesive pad for adhesion.

7. The magnetic positioning structure according to claim 6, wherein the adhesive pad is one selected from the group of a double-sided tape and a reusable nanopatch.

8. The magnetic positioning structure according to claim 6, wherein the at least one magnetic conductive element is attached on an inside or an outside of the housing.

9. The magnetic positioning structure according to claim 6, wherein the at least one magnetic conductive element is in a form corresponding to the housing of the expanded device.

10. The magnetic positioning structure according to claim 5, wherein the at least one first magnetic element and the second magnetic element with different opposite poles are arranged relative to each other, and the at least one first magnetic element and the second magnetic element are in a geometric shape selected from the group of a round shape, a rectangular shape, and a triangular shape.
